(19) United States
(12) Patent Application Publication
(10) Pub. No.: US 2019/0070803 A1
(43) Pub. Date: Mar. 7, 2019

(54) Improved Method For Manufacturing A Structural Component Of A Motor Vehicle

(71) Applicant: Compagnie Plastic Omnium, Lyon (FR)

(72) Inventor: Laurent Rocheblave, Villeurbanne (FR)

(21) Appl. No.: 16/064,819

(22) PCT Filed: Dec. 19, 2016
(86) PCT No.: PCT/FR2016/053542

§ 371 Date: Nov. 13, 2018

(30) Foreign Application Priority Data
Dec. 21, 2015 (FR) 1562985

(51) Int. Cl. B29C 70/78; B29C 70/68; B62D 25/04; B62D 29/00

(52) U.S. Cl. CPC B29C 70/78; B29C 70/681; B29K 2705/00; B62D 29/004; B62D 25/04

(57) ABSTRACT

The invention relates to a method for manufacturing a hybrid structure of a motor vehicle, including a step of assembling a structural element formed of a sheet of shaped metal material and a strip of composite material that includes at least one layer of fibres impregnated or embedded in a polymer matrix, covers a portion of a surface of said structural element, and is extracted from a large rectangular sheet including an upper edge and a lower edge which are parallel to one another, the strip of composite material being obtained by extracting a portion of the large sheet according to a first cut-out line and second cut-out line, each running from the upper edge to the lower edge. Each of the cut-out lines has a point of symmetry arranged equidistantly from the upper edge and the lower edge, such that any given point of a cut-out line is symmetrical, with respect to said point of symmetry, with another point belonging to said cut-out line.

### FIELD OF THE INVENTION

The invention relates to a method for manufacturing a hybrid structural part of a motor vehicle, formed by assembling several different materials, such as metal elements and polymer materials, in order to give the part special mechanical characteristics.

### BACKGROUND OF THE INVENTION

Certain structural elements of a motor vehicle are in fact highly stressed during an impact. They must be able to provide the rigidity and strength required to withstand the forces during the impact, and absorb some of the energy in order to preserve the integrity of the vehicle and ensure the safety of the passengers. This is the case for example of structural parts such as the B pillar, the outer longitudinal member, the roof cross-member, the bumper beam or, possibly, any other structural element of the vehicle.

These structural elements must also be strong enough to locally support various mechanical functions. This is the case, for example, of a motor vehicle B pillar, which is highly stressed during a lateral impact and which must also support the rear door via hinges and keep the front door closed via closure system thereof.

The hybrid structural parts, while offering the same mechanical strength, reduce the weight of the hybrid structural part and improve its shock-absorbing properties.

Publication EP1 550 604 proposes a method for manufacturing a hybrid structural part in which a metal structural element previously coated with a hot-reactivatable surface coating is shaped. A thermoplastic material is then added by overmolding, forming ribs on the surface of the metal structural element comprising the surface coating.

The case of a hybrid structure comprising a composite material comprising a layer of fibers impregnated in a polymer matrix is also known. This fiber layer generally consists of unidirectional fibers and optionally comprises one or more additional layers of woven fibers. The layer of composite material is shaped, preferably by hot stamping, directly in the preformed metal structural element after applying an interlayer of binding material. The stiffening elements, consisting of ribs, are then made by overmolding a thermoplastic or thermosetting polymer material, preferably in the same mold as that used in the stamping step. The composite material covers all or part of said surface of the metal structural element, and the polymer material may then cover all or part of the composite material, and some of the spaces in the metal structural element left empty by the sheet of composite material.

To produce a composite structural part, a strip of composite material must be extracted from a generally flat sheet or from a larger sheet.

This large sheet may be a continuous sheet consisting of a wound sheet of given width, or consisting of sheets of given length and width; in this case, large means the fact that several strips of composite material can be extracted from a given large sheet.

The shape of the contours of this strip of composite material is determined by calculation and/or experimentally, so as to be able to adjust, after stamping, to the relief shape of the metal structural element, while taking into account the geometric changes imposed on the strip of composite material and occurring during this stamping operation. Thus, in order to optimally cover a surface of the metal structure, said surface generally being formed by the internal surface, strip shapes with highly irregular edges requiring precise cutting are obtained.

This procedure has the disadvantage of generating scraps of composite material when extracting the strips from the large sheet.

### SUMMARY OF THE INVENTION

The object of the invention is to reduce to virtually zero the amount of scraps of composite material generated when implementing the method described above.

Contrary to preconceived ideas, it has been demonstrated that the strip of composite material does not have to cover the entire area of the internal surface of the metal structural element to obtain the required mechanical effects, provided that the fibers are present on the portions of the surface which are subjected to the highest stress. This observation made it possible to simplify the shape of the strips of composite material.

The method according to the invention relates to the manufacture of a hybrid structure of a motor vehicle, comprising a step of assembling a preformed metal structural element and a strip of composite material comprising at least one layer of fibers impregnated or embedded in a polymer matrix, covering a portion of at least one surface of said metal structural element. This strip of composite material is extracted from a large rectangular sheet comprising an upper edge and a lower edge which are parallel to one another, the strip of composite material being obtained by extracting a portion of the large sheet according to a first cut-out line and a second cut-out line, each running from the upper edge to the lower edge.

According to the invention, the shape of the strip of composite material is adjusted by calculation and/or by successive experimental approximations such that each of the cut-out lines has a point of symmetry arranged equidistantly from the upper edge and the lower edge, such that any given point of a cut-out line is symmetrical, with respect to said point of symmetry, with another point belonging to said cut-out line.

These arrangements make it possible to extract strips of composite material whose contours have identical geometries, and which are therefore perfectly superimposable, while limiting the scraps to only those portions of the large sheet at the two longitudinal ends of said sheet. As will be seen below, this procedure can be optimized so that these latter scraps are reduced to zero.

Despite the above-mentioned limitations, the variety of geometric shapes that can be produced by implementing the method according to the invention is sufficient to cover most of the practical cases for manufacturing a hybrid structure of a motor vehicle.

After the extraction step, the strip of composite material thus obtained is assembled with the metal structural element, preferably by hot stamping.

The method according to the invention may also comprise the following characteristics, taken alone or in combination:

adjacent strips are extracted by successively making a cut along the first cut-out line then a cut along the second cut-out line.

the centers of symmetry of the cut-out lines are arranged equidistantly from each other.

at least one of the cuts is straight and forms a right angle with the upper and lower edges.

the lines formed by the first and second cuts intersect at a point on the first or second edge.

the first cut-out line and the second cut-out line are partially superimposed.

the strips of composite material are superimposable.

the strip of composite material comprises a layer of unidirectional fibers impregnated or embedded in a matrix of polymer material.

the strip of composite material is formed by superimposing several identical strips of composite material, extracted from a large sheet.

the strip of composite material is assembled with the metal structural element by hot stamping said strip of composite material under temperature and pressure conditions adapted to give the strip of composite material the same shape as that of the surface of the metal structural element.

after the step of assembling the metal structural element and the strip of composite material, all or some of the strip of composite material and the surface of the metal structural element are covered, preferably by molding, with a polymer material having stiffening ribs.

the polymer material covers the strip of composite material over an area of between 10% and 50%, and preferably over an area of between 15% and 40%, of the total area of the surface of the hybrid structural part.

### BRIEF DESCRIPTION OF THE DRAWINGS

The invention will be better understood on reading the accompanying figures, which are given solely by way of example and not limiting in any way, in which:

FIG. 1 shows a large sheet formed of a composite material, from which strips according to the invention are extracted.

FIG. 2 shows two adjacent strips of composite material.

FIG. 3 shows a large sheet formed from a composite material, from which strips of composite material of trapezoidal shape are extracted.

FIG. 4 shows a first alternative embodiment of the invention.

FIG. 5 shows a second alternative embodiment of the invention.

FIG. 6 shows a strip of composite material obtained by superimposing two strips of identical shape and area.

FIG. 7 shows the metal structure of a B pillar and the strip of composite material before they are assembled.

FIG. 8 shows the B pillar after stamping the strip of composite material in the metal structure.

FIG. 9 shows the B pillar after injecting the stiffening ribs made of polymer material.

### DETAILED DESCRIPTION OF THE INVENTION

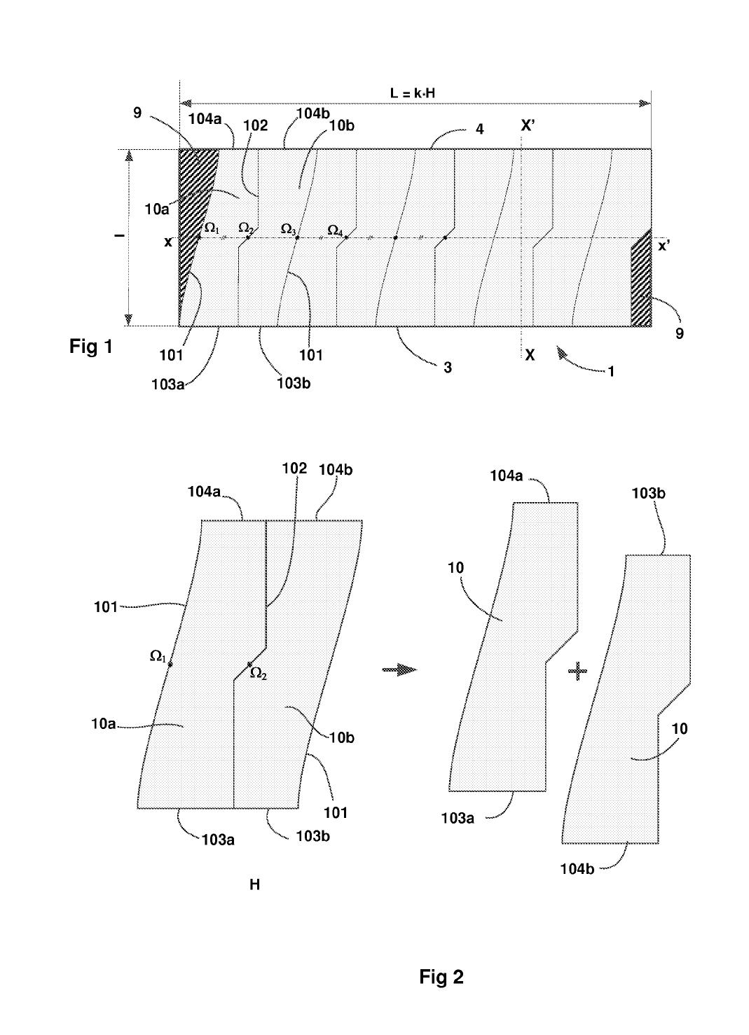

FIG. 1 illustrates a large sheet 1 of length L and width I from which a plurality of portions of sheets 10a, 10b forming strips of composite material 10 are extracted. The large sheet 1 comprises a lower edge 3 and an upper edge 4, which are parallel to one another.

The composite material forming the sheet generally comprises a layer of fibers impregnated or embedded in a thermoplastic or thermosetting polymer matrix. This layer of fibers may be formed by a layer of unidirectional fibers, or a layer of woven fibers, or by assembling unidirectional fibers and woven fibers. The unidirectional fibers are arranged parallel to one another, at a given pitch. They can be oriented in the direction of the length and more generally in the direction of the width of the large sheet.

Sheets of unidirectional fibers are usually manufactured on industrial scale by producing bands wound on themselves in which the fibers are arranged in the strip unwinding direction. Thus, in order to obtain strips of composite material comprising fibers oriented in the direction of the longest dimension of the metal structural element, the strips must be extracted from large sheets in which the fibers are oriented in the direction of the width.

To obtain said large sheet, the band is unwound, and a portion of band having a length equal to the width of said large sheet is cut out, along a cut-out line perpendicular to the direction of the stiffening fibers of the band.

To detach a portion of sheet 10a and obtain a sheet of composite material, a cut is made along a first cut-out line 101, then a second cut along a second cut-out line 102. Each of these cuts extends along the width of the large sheet from the lower edge 3 to the upper edge 4.

The first cut-out line comprises a centre of symmetry Ω₁, arranged equidistantly from edges 3 and 4, the second cut-out line 102 comprises a centre of symmetry Ω₂, also equidistantly from edges 3 and 4. These centers of symmetry are therefore placed on a fictitious line xx′ parallel to the edges and equidistant from them.

The first cut-out line 101 is defined such that any given point of this cut-out line is symmetrical, with respect to the point Ω₁, with another point belonging to this same cut-out line 101. And any given point of the second cut-out line 102 is symmetrical, with respect to the point Ω₂, with another point of said second cut-out line 102.

The next strips are cut by making alternate cuts along the first cut-out line 101 then a cut along the second cut-out line 102. Care must also be taken to ensure that the distance separating two adjacent centers of symmetry (Ω₁, Ω₃, Ω₄) is constant.

By matching the lower edge 103a of the strip 10a with the upper edge 104b of the strip 10b, and the upper edge 104a of the strip 10a with the lower edge 103b of the strip 10b, superimposable strips of composite material 10 are obtained, as illustrated on FIG. 2.

Note, however, that portions 9 of the large sheet 1 at the two longitudinal ends thereof are scraps. One way of reducing these scraps is to ensure that the length L of the large sheet corresponds to an integer number of strips 10, as illustrated on FIG. 1.

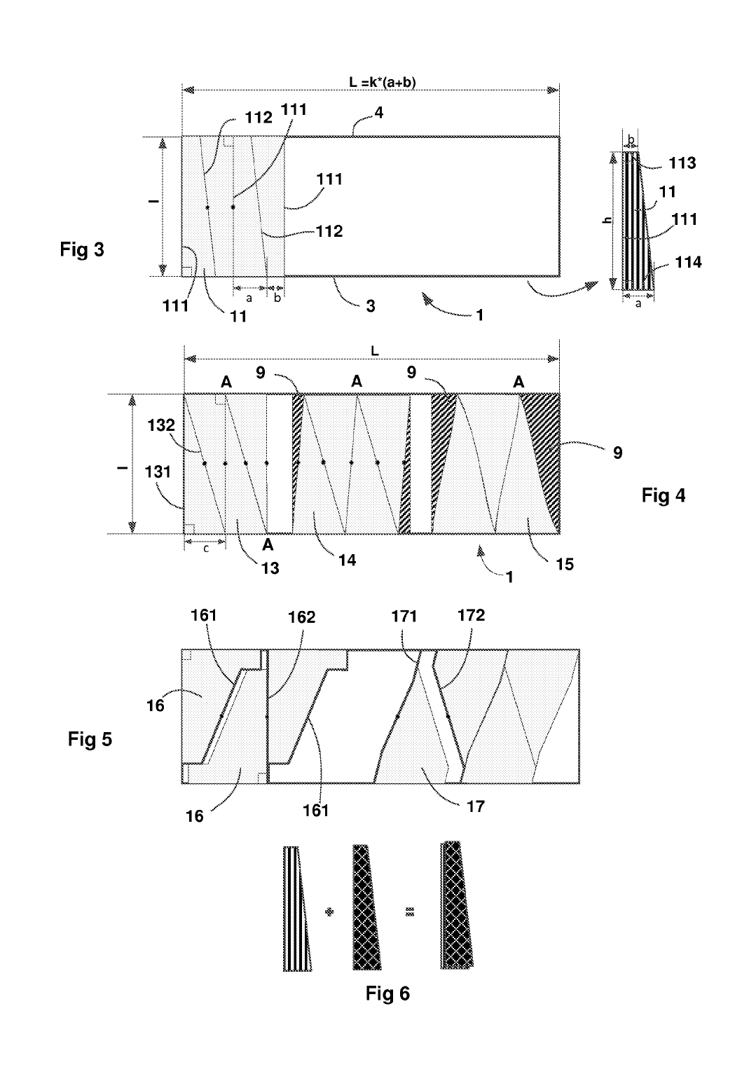

To further reduce the amount of scraps generated by this industrial operation, it is proposed to extract portions of sheet by making at least one straight cut 111 perpendicular to the lower and upper edges 3 and 4, as illustrated on FIG. 3.

The second cut-out line 112 can have any shape, provided that it respects the above-mentioned symmetry criterion. Note that the assembly of two consecutive strips has the shape of a rectangle.

Thus, to reduce the scraps to zero, a large sheet will be chosen, whose length L is equal to an integer multiple of the width of the rectangle formed by placing two identical strips next to each other, and in this case, of the sum of the length a of the lower edge 114 and of the length b of the upper edge 113.

FIG. 4 illustrates a first alternative embodiment in which the first cut-out line and the second cut-out line intersect at a point a placed on one of the two edges. Several shapes of cut-out line are possible.

Thus, the first cut-out line of the portion 13 is perpendicular to the edges. As explained above, this arrangement reduces the scraps to zero. The second cut 132 can have any shape, within the limits defined by the invention. When the second cut is straight, the strip obtained has the shape of a right-angled triangle.

The portions of sheets, forming the strips 14 and 15, whose first and second cuts are not perpendicular to the edges, generate scraps 9 at the start and end of the sheet.

FIG. 5 illustrates another alternative embodiment, in which the first and second cuts are superimposed over part of their lengths. Considering the imposed symmetry, this superimposition occurs on the two portions of the cut located at each edge.

The strips 16 are obtained by a first cut 161 and a second cut 162. This second cut 162 is straight and perpendicular to the edges.

The strips 17 are obtained by cutting along lines 171 and 172.

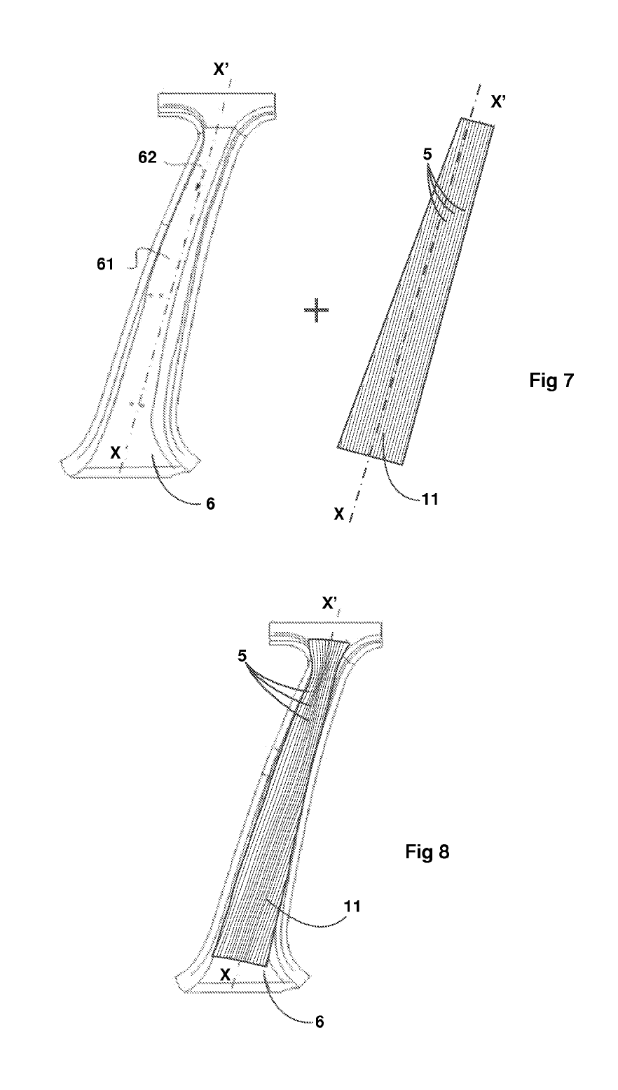

Generally, the direction of the unidirectional fibers is chosen parallel to the largest dimension of the part of composite material to be produced and acting as main direction XX′, also with reference to FIG. 7. Under these conditions, the unidirectional fibers will be oriented in the direction of the width of the large sheet, as illustrated on FIG. 1.

When the sheet of composite material 1 has several layers of unidirectional fibers, they are preferably all aligned in the same main direction XX′.

Two strips extracted from different large sheets or from the same large sheet can usefully be superimposed to form a single strip of composite material, as illustrated on FIG. 6. The polymer matrices of each of the two strips, which were chosen so as to be compatible with one another, are then intimately welded together under the effect of pressure and temperature during the hot stamping step.

The fibers may be the same type or different, and are chosen from fibers such as glass fibers, carbon fibers, basalt fibers, metal fibers and aramid fibers.

The polymer matrix coating the fibers may be of the thermoplastic type and usefully be chosen from aliphatic polyamides (PA), polyphthalamides (PPA), polybutylene terephthalate (PBT), polyethylene terephthalate (PET), polycarbonates (PC), or even polypropylene, and mixtures thereof. For example, polyamide 66 (PA66) or polyamide 6 (PA6) can be used. The polymer matrix may also be of the thermosetting type. In this case, a polyester, vinyl ester, epoxy, polyurethane resin, or a mixture thereof, will preferably be chosen.

The thickness of the strip of composite material may be from 3 to 6 mm, advantageously from 3 to 5 mm, preferably from 4 to 5 mm.

FIG. 7 illustrates a metal structural element 6 shaped and intended to form the B pillar 8 of a motor vehicle, and the strip of composite material 11 associated with it and which has the shape of a right trapezium. This metal structural element, generally obtained by stamping a sheet of metal, has an internal surface 61 of generally concave shape, and an external surface 62 opposite the internal surface 61.

The unidirectional fibers 5 of the strip of composite material are oriented along a main direction XX′, corresponding to the direction of the largest dimension of the metal structural element.

A layer of binding material is inserted between the metal structure and the strip of composite material, before the hot stamping operation.

FIG. 8 illustrates the structure obtained after the hot stamping operation, during which the strip of composite material is molded onto the internal surface 61 of the metal structural element.

Note that the fibers 5 have been moved transversely and that the regular pitch between the fibers observed on the strip before stamping (see FIG. 7) is subjected to strong local disturbances. These movements make it possible to closely follow the surface of the metal structural element.

Thus, the size of the strip of composite material is obtained by calculation and/or by successive experimental approximations, while trying to obtain a substantially regular coverage of the internal surface 61 of the metal structural element. The final shape of the strip corresponds to that which generates a minimum scrap rate and corresponds to the characteristics described above.

When developing the method, special attention will be paid to the stamping step during which the strip of composite material may overlap the edges of the surface to be covered. These excesses of material, if they should reoccur, would require an operator intervention to remove the excess material and would also generate an unwanted scrap. In this case, the dimensions of the strip are adjusted to eliminate these excesses of material.

Once the hot stamping operation has been performed, injection molding of the polymer material is carried out by producing the stiffening ribs 7 which cover all or part of the strip of composite material 11 and all or part of the metal structural element 6. Care must be taken to ensure that the polymer material covers the strip of composite material over an area of between 10% and 50%, and preferably over an area of between 15% and 40%, of the total area of the surface of the hybrid structural part.

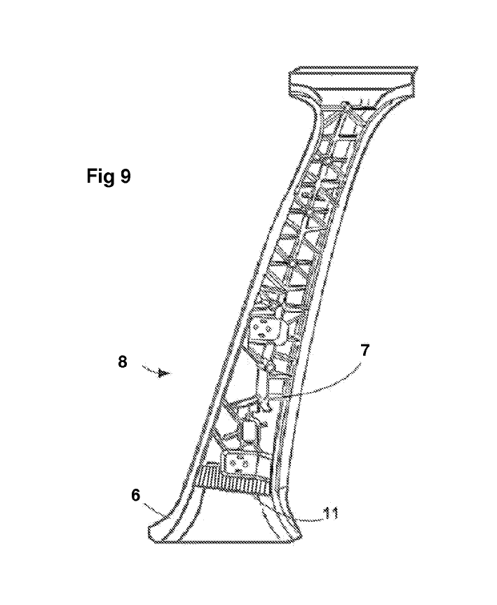

A hybrid structural part 8, as illustrated on FIG. 9, is then obtained, having all the expected mechanical and impact resistance qualities.

### BILL OF MATERIALS

Large rectangular sheet.
10, 10a, 10b, 11, 12, 13, 14, 15, 16, 17 Strip of composite material.
101, 111, 121, 131, 141, 151, 161, 171 First cut-out line.
102, 112, 122, 132, 142, 152, 162, 172 Second cut-out line.
3 Lower edge of the large sheet.
4 Upper edge of the large sheet.
103a, 103b, 113 Upper edge of the strip of composite material.
104a, 104b, 114 Lower edge of the strip of composite material.
5 Stiffening fibers of the strip of composite material.
6 Metal structural element of a B pillar.
61 Internal surface of the metal structural element.
62 External surface of the metal structural element.
7 Stiffening ribs made of polymer material.
8 Hybrid structural part forming a B pillar of a motor vehicle.
9 Scraps.
L Length of the large sheet.
I Width of the large sheet.
a Length of the large base of the trapezium.
b Length of the small base of the trapezium.
c Length of the lower edge of the strip of composite material having the shape of a right-angled triangle.
Ω₁, Ω₂, Ω₃, Ω₄ Centre of symmetry of a cut-out line.

1. A method for manufacturing a hybrid structural part of a motor vehicle, comprising a step of assembling a preformed metal structural element and a strip of composite material comprising at least one layer of fibers impregnated or embedded in a polymer matrix, covering a portion of at least one surface of said metal structural element, and extracted from a rectangular sheet comprising an upper edge and a lower edge which are parallel to one another, the strip of composite material being obtained by extracting a portion of the rectangular sheet according to a first cut-out line and a second cut-out line, each running from the upper edge to the lower edge, wherein the shape of the strip of composite material is adjusted by calculation and/or by successive experimental approximations such that each of the cut-out lines has a point of symmetry (Ω) arranged equidistantly from the upper edge and the lower edge, such that any given point of a cut-out line is symmetrical, with respect to said point of symmetry (Ω), with another point belonging to said cut-out line.

2. The manufacturing method according to claim 1, wherein adjacent strips are extracted by successively making a cut along the first cut-out line, then a cut along the second cut-out line.

3. The manufacturing method according to claim 2, wherein the centers of symmetry (Ω) of the cut-out lines of the strips are arranged equidistantly from each other.

4. The manufacturing method according to claim 1, wherein at least one of the cuts is straight and forms a right angle with the upper and lower edges.

5. The manufacturing method according to claim 1, wherein the lines formed by the first and second cuts intersect at a point (A) on the upper edge or on the lower edge.

6. The manufacturing method according to claim 1, wherein the first cut-out line and the second cut-out line are partially superimposed.

7. The manufacturing method according to claim 1, wherein the strips of composite material are superimposable.

8. The manufacturing method according to claim 1, wherein the strip of composite material comprises a layer of unidirectional fibers impregnated or embedded in a matrix of polymer material.

9. The manufacturing method according to claim 1, wherein the strip of composite material is formed by superimposing several identical strips of composite material, extracted from the rectangular sheet.

10. The manufacturing method according to claim 1, wherein the strip of composite material is assembled with the metal structural element by hot stamping the strip of composite material under temperature and pressure conditions adapted to give the strip of composite material the same shape as that of the surface of the metal structural element.

11. The manufacturing method according to claim 1, wherein, after the step of assembling the metal structural element and the strip of composite material, all or some of the strip of composite material and the surface of the metal structural element are covered by molding, with a polymer material having stiffening ribs.

12. The manufacturing method according to claim 11, wherein the polymer material covers the strip of composite material over an area of between 10% and 50%, and preferably over an area of between 15% and 40%, of the total area of the surface of the hybrid structural part.
